(19) United States
(12) Patent Application Publication
(10) Pub. No.: US 2013/0198409 A1
(43) Pub. Date: Aug. 1, 2013

(54) EFFICIENT IMPLEMENTATION OF USER-PROVIDED DNS NAMES

(71) Applicants: Grant A. Holliday, Canberra (AU); Craig A. Harry, Wake Forest, NC (US)

(72) Inventors: Grant A. Holliday, Canberra (AU); Craig A. Harry, Wake Forest, NC (US)

(73) Assignee: MICROSOFT CORPORATION, Redmond, WA (US)

(21) Appl. No.: 13/364,229

(22) Filed: Feb. 1, 2012

(51) Int. Cl. G06F 15/173

(52) U.S. Cl. 709/238

(57) ABSTRACT

Embodiments are directed to automatically redirecting DNS requests for DNS names while the DNS names are not resolvable. In one scenario, a domain name system (DNS) server establishes a wildcard DNS entry for a specified domain name. Incoming DNS requests for that domain name are automatically forwarded to a load balancer. The load balancer inspects packet headers for each received DNS request to determine which hostname was indicated in the DNS request. The load balancer then accesses a mapping file to determine which back-end server the DNS request is to be redirected to based on the hostname indicated in the packet header and, based on the determination, forwards the received request to the determined back-end server.

### BACKGROUND

Computers have become highly integrated in the workforce, in the home, in mobile devices, and many other places. Computers can process massive amounts of information quickly and efficiently. Software applications designed to run on computer systems allow users to perform a wide variety of functions including business applications, schoolwork, entertainment and more. Software applications are often designed to perform specific tasks, such as word processor applications for drafting documents, or email programs for sending, receiving and organizing email.

In some cases, software applications are designed to interact with other software applications or other computer systems. For example, internet browser applications allow users to connect to other web servers to view content on web pages. The internet browsers allow users to type in web addresses (i.e. domain names) that are translated into internet protocol (IP) addresses by a domain name system (DNS). The user sends his or her data request in the form of a domain name (e.g. “www.example.com”) which is translated by a DNS server into a string of numbers (the IP address). The user's request is then forwarded to that IP address. DNS servers receive updates of new web pages that have been added to the web. However, an unpredictable amount of time is needed for the domain name to be propagated through the DNS system.

### BRIEF SUMMARY

Embodiments described herein are directed to automatically redirecting DNS requests for DNS names while the DNS names are not resolvable. In one embodiment, a domain name system (DNS) server establishes a wildcard DNS entry for a specified domain name. Incoming DNS requests for that domain name are automatically forwarded to a load balancer. The load balancer inspects packet headers for each received DNS request to determine which hostname was indicated in the DNS request. The load balancer then accesses a mapping file to determine which back-end server the DNS request is to be redirected to based on the hostname indicated in the packet header and, based on the determination, forwards the received request to the determined back-end server.

In another embodiment, a DNS server system performs an alternative method for automatically redirecting DNS requests for DNS names while the DNS names are not resolvable. The DNS server establishes a non-wildcard DNS entry for a specified domain name that maps to a specified service instance. The DNS server inspects packet headers for each received DNS request to determine which service instance was indicated in the DNS request and, based on the determination, forward incoming DNS requests for that service instance to the specified service instance.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments of the invention may be realized and obtained by means of the instruments and combinations particularly pointed out in the appended claims. Features of the embodiments of the present invention will become more fully apparent from the following description and appended claims, or may be learned by the practice of the invention as set forth hereinafter.

### BRIEF DESCRIPTION OF THE DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The embodiments of the invention will be described and explained with additional specificity and detail through the use of the accompanying drawings in which:

FIG. 1 illustrates a computer architecture in which embodiments of the present invention may operate including automatically redirecting DNS requests for DNS names while the DNS names are not resolvable.

FIG. 2 illustrates a flowchart of an example method for automatically redirecting DNS requests for DNS names while the DNS names are not resolvable.

FIG. 3 illustrates a flowchart of an alternative example method for automatically redirecting DNS requests for DNS names while the DNS names are not resolvable.

FIG. 4 illustrates an embodiment of the present invention in which DNS requests are automatically redirected while the DNS names are not resolvable.

### DETAILED DESCRIPTION

Embodiments described herein are directed to automatically redirecting DNS requests for DNS names while the DNS names are not resolvable. In one embodiment, a domain name system (DNS) server establishes a wildcard DNS entry for a specified domain name. Incoming DNS requests for that domain name are automatically forwarded to a load balancer. The load balancer inspects packet headers for each received DNS request to determine which hostname was indicated in the DNS request. The load balancer then accesses a mapping file to determine which back-end server the DNS request is to be redirected to based on the hostname indicated in the packet header and, based on the determination, forwards the received request to the determined back-end server.

In another embodiment, a DNS server system performs an alternative method for automatically redirecting DNS requests for DNS names while the DNS names are not resolvable. The DNS server establishes a non-wildcard DNS entry for a specified domain name that maps to a specified service instance. The DNS server inspects packet headers for each received DNS request to determine which service instance was indicated in the DNS request and, based on the determination, forward incoming DNS requests for that service instance to the specified service instance.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions in the form of data are computer storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM, solid state drives (SSDs) that are based on RAM, Flash memory, phase-change memory (PCM), or other types of memory, or other optical disk storage, magnetic disk storage or other magnetic storage devices, or any other medium which can be used to store desired program code means in the form of computer-executable instructions, data or data structures and which can be accessed by a general purpose or special purpose computer.

A “network” is defined as one or more data links and/or data switches that enable the transport of electronic data between computer systems and/or modules and/or other electronic devices. When information is transferred or provided over a network (either hardwired, wireless, or a combination of hardwired or wireless) to a computer, the computer properly views the connection as a transmission medium. Transmission media can include a network which can be used to carry data or desired program code means in the form of computer-executable instructions or in the form of data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”), and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems that are linked (either by hardwired data links, wireless data links, or by a combination of hardwired and wireless data links) through a network, each perform tasks (e.g. cloud computing, cloud services and the like). In a distributed system environment, program modules may be located in both local and remote memory storage devices.

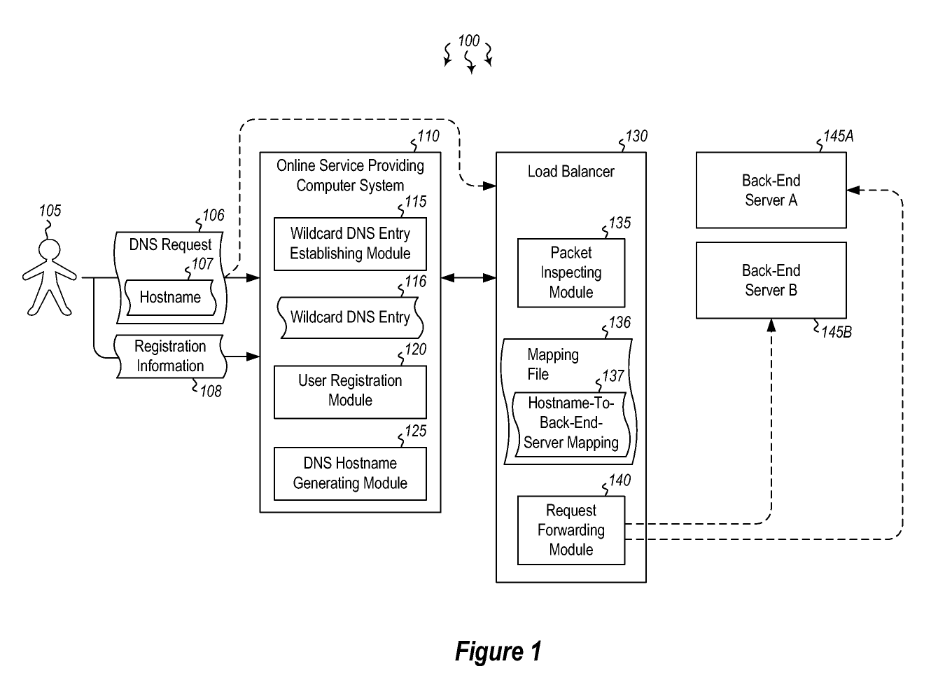

FIG. 1 illustrates a computer architecture 100 in which the principles of the present invention may be employed. Computer architecture 100 includes an online service providing computer system, a load balancer and one or more back-end server computer systems. Each of these computer systems may be any type of local or distributed computer system, including a cloud computing system. The computer systems include various modules for performing a variety of different functions. For instance, the online service providing computer system 110 may provide one or more online services for various users or customers. The computer system 110 includes a user registration module 120 that receives user registration information 108. In this manner, the online service providing computer system 110 allows a user to register their own service and define their own DNS hostname to access the service. This allows the user to personalize the service and use a hostname that is (potentially) easier for the user to remember.

The service registered by the user may include any type of web page, web service, software application or other type of service. The DNS hostname generating module 125 may generate or otherwise designate that a certain DNS name has been registered by a user (e.g. user 105). However, once that DNS name has been registered, it takes a certain amount of time for that new hostname to propagate to other end-user's DNS servers. This introduces a delay between when a user/customer can specify their hostname and when they can reliably connect to it.

Embodiments described herein include a combination of wildcard DNS entries (e.g. 116) and a (software) load balancer to direct network traffic while the DNS name is not resolvable. It should be noted that the load balancer may be implemented solely in hardware, solely in software, or in a combination of hardware and software. The wildcard DNS entry establishing module 115 of the online service providing computer system 110 may establish a wildcard DNS entry 116 that forwards all requests for that DNS name to a certain internet protocol (IP) address. Thus, wildcard DNS entry 116 may indicate that any incoming requests for a specified DNS name (e.g. *.app.com) are forwarded to the IP address of the load balancer 130.

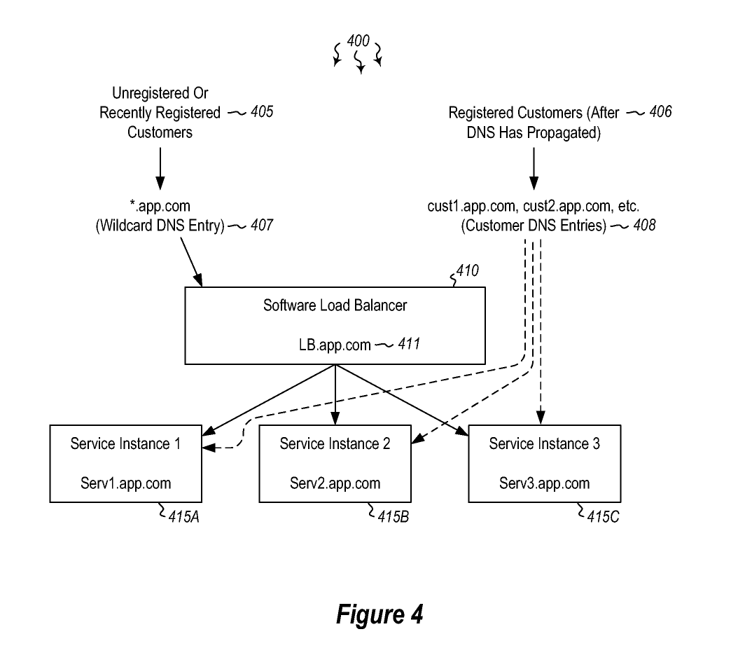

As shown in computing environment 400 of FIG. 4, if an unregistered or a recently registered customer 405 (or other internet user) sent a request for service instance 1 (415A), for example, by typing “serv1.app.com” into an internet browser application, the wildcard DNS entry 407 for *.app.com will forward that request to the IP address of the software load balancer 410 (LB.app.com). It should be noted that the asterisk (“*”) represents any set of characters. Thus, requests for [any_characters].app.com will be handled by the wildcard DNS entry, and will be forwarded to the load balancer. The load balancer inspects the header information of the DNS request 106 of FIG. 1 to determine which hostname 107 was indicated in the request. The load balancer consults a mapping file 136 with multiple different hostname-to-back-end-server mappings 137 to determine which back-end server the DNS request is to be forwarded to. The request forwarding module 140 then forwards the DNS request to the appropriate back-end server (e.g. 145A or 145B).

Thus, embodiments herein implement a wildcard DNS entry, DNS entries for each customer using their specified name (e.g. the DNS name for which they registered), and a software load balancer that utilizes the hypertext transfer protocol (HTTP) host header information to route traffic to the appropriate back-end server. The wildcard DNS entry (e.g. *.app.com) points to the public DNS name or IP address of the software load balancer (e.g. LB.app.com). The software load balancer has a mapping of registered hostnames and service instances associated with those hostnames.

For example, customer1.app.com may map to service instance 1 (serv1.app.com), while customer2.app.com maps to service instance 2 serv2.app.com and customer3.app.com maps to service instance 1 serv1.app.com. When a customer registers for the service and specifies their own DNS name, the registering service updates the software load balancer with the additional HTTP host header that maps to the service instance that the customer's data is hosted on.

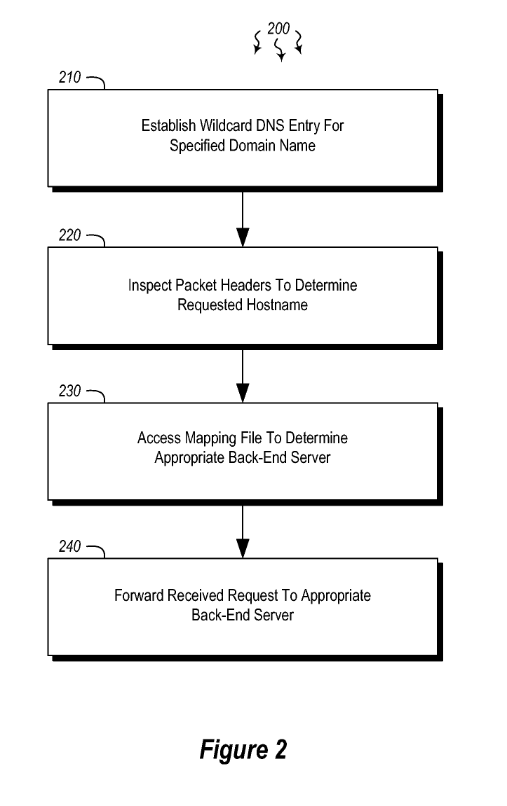

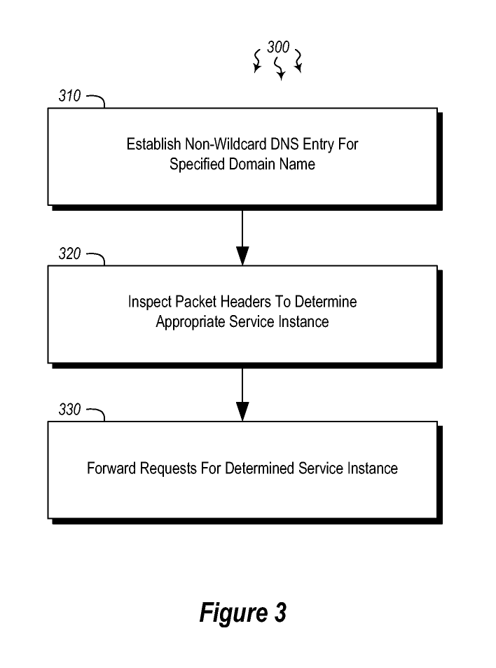

Before the user's registered DNS name has propagated and the user tries to access the registered DNS hostname, the software load balancer accepts the DNS request and then inspects the HTTP host header for the DNS hostname that the user entered. The software load balancer then consults its mapping file to determine which back-end server the request is to be forwarded to. Additionally, in some embodiments, a non-wildcard DNS entry may also be created that maps to a specific service instance. Such embodiments may remove the software load balancer as a bottleneck or single point of failure. The various embodiments described herein allow customers or other users to use their supplied DNS hostname immediately without waiting for DNS propagation to occur. These concepts will be explained further below with regard to methods 200 and 300 of FIGS. 2 and 3, respectively.

In view of the systems and architectures described above, methodologies that may be implemented in accordance with the disclosed subject matter will be better appreciated with reference to the flow charts of FIGS. 2 and 3. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 2 illustrates a flowchart of a method 200 for automatically redirecting DNS requests for DNS names while the DNS names are not resolvable. The method 200 will now be described with frequent reference to the components and data of environments 100 and 400 of FIGS. 1 and 4, respectively.

Method 200 includes an act of establishing a wildcard DNS entry for a specified domain name, wherein incoming DNS requests for that domain name are automatically forwarded to a load balancer (act 210). For example, the wildcard DNS entry establishing module 115 of online service providing computer system 110 may establish a wildcard DNS entry 116 for a specified domain name. Thus, a user (e.g. 105) may register for a specified DNS name. The user may send registration information 108 to user registration module 120 to register the DNS name. The DNS name may be any series of letters and/or numbers that ends in a top level domain (TLD) such as .com, .net or .edu, etc. In one example, the DNS name the user (or customer) has registered for is cust1.app.com. The data and other items related to this DNS name may be provided by one or more different service instances (e.g. 415A-C) on one or more back-end servers (145A/145B). In one embodiment, cust1.app.com may be provided by service instance 1 (415A).

In this example, the wildcard DNS entry 116 established by module 115 is “*.app.com” 407. This wildcard entry is then used to forward DNS requests for any

DNS addresses that end in “app.com”. The wildcard DNS entry (at least in some embodiments) points to the public DNS or IP address of a software load balancer 130/410. Then, any incoming requests that end in “app.com” are automatically forwarded to the load balancer. In some cases, wildcard DNS entries may correspond to a specific user. As such, the wildcard DNS entry may apply to all domain names controlled by or registered to a specific user or customer. Moreover, it should be noted that while the load balancer in FIG. 4 is referred to as a software load balancer, a hardware or a software load balancer may be used to perform the load-balancing, packet inspection and other functionality of the load balancer.

In method 200, the load balancer inspects packet headers for each received DNS request to determine which hostname was indicated in the DNS request (act 220). For instance, the packet inspecting module 135 inspects packet headers in DNS request 106 to determine which hostname 107 had been typed in by the user. The hostname may be a DNS name selected by a user. As mentioned previously, the online service providing computer system may provide a service which allows users to select their own DNS names. This service may be provided to many hundreds or thousands of users (or more). As such, each customer's database is to be associated with a server or service instance. The server or service instance may then host content provided at that DNS name. The customer may thus select the DNS name and control the content related to that DNS name.

After inspecting the DNS request to determine the requested hostname, the load balancer accesses a mapping file to determine which back-end server the DNS request is to be redirected to based on the hostname indicated in the packet header (act 230). Thus, load balancer 130 may access mapping file 136 to determine, based on a hostname-to-back-end server mapping which back-end server is currently being used to provide content related to the DNS name in the request. In one example, back-end server A (145A) may provide the service instance (e.g. 415A) that provides the web or other content related to the DNS name in the request. As back-end servers and/or service instances may change over time, the mapping file 136 may be updated dynamically as changes are made, or on a scheduled (e.g. hourly, daily or weekly) basis.

The mapping file may include a listing of registered users and each user's service instance(s). Each registered user may have their own content stored in a database or other data store. Multiple different back-end servers may be used to service requests for a specified domain name. In some cases, each service instance may serve a different set of customer databases. Thus, for instance, service instance 1 (415A), service instance 2 (415B) and service instance 3 (415C) may each service different customer databases.

Method 200 further includes an act of forwarding the received request to the determined back-end server based on the indication in the mapping file (act 240). Thus, upon determining that a DNS request is to be forwarded to back-end server B (145B), for example, the request forwarding module 140 of the load balancer 130 forwards the DNS request 106 to back-end server B. As such, until the DNS name selected by the user 105 propagates through the (local and/or worldwide) DNS system, the wildcard DNS entry will forward requests to the load balancer which will then forward the requests to the appropriate back-end server (and/or service instance). Once a specified DNS name is resolvable (e.g. after the DNS name has propagated 406), the wildcard DNS entry and load balancer are bypassed. Then, the DNS requests go directly to the appropriate service/server instance, as shown in FIG. 4.

For instance, customer DNS entries such as cust1.app.com and cust2.app.com may correctly resolve using the normal DNS system, and requests for those domains may simply be forwarded using the normal DNS system. The load balancer, the mapping file and the wildcard DNS entry are no longer needed and are automatically bypassed when the DNS name resolves correctly. As such, embodiments described herein may be implemented to allow users to connect to the appropriate back-end servers while the DNS name is not resolving. Then, when the DNS name resolves correctly, the load balancer and other elements are bypassed automatically.

FIG. 3 illustrates a flowchart of a method 300 for automatically redirecting DNS requests for DNS names while the DNS names are not resolvable. The method 300 will now be described with frequent reference to the components and data of environments 100 and 400 of FIGS. 1 and 4, respectively.

Method 300 includes an act of establishing a non-wildcard DNS entry for a specified domain name that maps to a specified service instance (act 310). For example, online service providing computer system may establish a non-wildcard DNS entry for a specified domain name (e.g. cust1.app.com) that maps to a service instance 2 (415B). This service instance may be run on the domain name serv2.app.com, as shown in FIG. 4. The specified domain name may be selected by a user (e.g. user 105). Thus, in contrast to wildcard DNS entries that allow a whole subset of entries to point to a single service instance, a non-wildcard DNS entry may work for a single DNS hostname, and may point directly to the customer's corresponding service instance.

In cases where multiple non-wildcard DNS entries have been generated, each non-wildcard DNS entry corresponds to a specific user. Each user may have one or more databases that include data that is to be provided by an associated service instance (e.g. service instance 2 (415B)). Each user may register for non-wildcard DNS entries on a website provided by a hosting service (e.g. the online service providing computer system 110. Each service instance may serve a different set of customer databases. Or, alternatively, each service instance may serve a plurality of customer databases.

Method 300 further includes an act of inspecting packet headers for each received DNS request to determine which service instance was indicated in the DNS request (act 320). For example, the packet inspecting module 135 may inspect packet headers for DNS request 106 to determine which service instance (e.g. 415A-C) was specified in the request. If the packet header indicates, for instance, that service instance 3 (415C) is to be used to service the DNS request, the packet inspecting module will read the packet header and prepare the DNS request for forwarding. It should be noted that although the packet inspecting module 135 is shown as being part of the load balancer 130, the packet inspecting module may be part of the online service providing computer system 110 or as part of another computer system. Similarly, the request forwarding module 140 may also be part of the service providing computer system or as part of another computer system.

Then, based on the determination, method 300 includes an act of forwarding incoming DNS requests for that service instance to the specified service instance (act 330). Thus, based on which service instance was indicated in the DNS request, the request forwarding module 140 forwards the DNS request 106 to the determined appropriate service instance. In this manner, because the packet inspecting module and request forwarding module may be placed on other computer systems, the load balancer may be avoided and, at least in some cases, not used in this non-wildcard scenario. This may prevent the load balancer from being a single potential point of failure.

Accordingly, as described in the various different embodiments described above, methods, systems and computer program products are provided which automatically redirect DNS requests for DNS names while the DNS names are not resolvable. Once the DNS names are propagated and are resolvable, the conventional DNS system is used to resolve the DNS requests.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. At a domain name system (DNS) server including at least one processor and a memory, in a computer networking environment including a plurality of computing systems, a computer-implemented method for automatically redirecting DNS requests for DNS names while the DNS names are not resolvable, the method comprising:
an act of establishing a wildcard DNS entry for a specified domain name, wherein incoming DNS requests for that domain name are automatically forwarded to a load balancer;
an act of the load balancer inspecting packet headers for each received DNS request to determine which hostname was indicated in the DNS request;
an act of the load balancer accessing a mapping file to determine which back-end server the DNS request is to be redirected to based on the hostname indicated in the packet header; and
based on the determination, an act of forwarding the received request to the determined back-end server.

2. The method of claim 1, wherein the load balancer comprises at least one of a software load balancer and a hardware load balancer.

3. The method of claim 1, wherein the wildcard DNS entry corresponds to a specific user.

4. The method of claim 1, wherein the wildcard DNS entry points to the public internet protocol (IP) address of the load balancer.

5. The method of claim 1, wherein each user's database is associated with a service instance.

6. The method of claim 5, wherein the mapping file includes a listing of registered users and each user's service instance.

7. The method of claim 1, wherein upon determining that a specified DNS name is resolvable, the wildcard DNS entry and load balancer are bypassed.

8. The method of claim 1, wherein the specified domain name for which the wildcard DNS entry is established comprises a customer-selected DNS name.

9. The method of claim 1, wherein a plurality of different back-end servers are used to service requests for a specified domain.

10. The method of claim 1, wherein each service instance serves a different set of customer databases.

11. The method of claim 1, further comprising:
an act of receiving registration information from a user, the registration information indicating a specified service and DNS name; and
an act of dynamically updating the mapping file to map to the service instance that the user's data is hosted on.

12. The method of claim 1, wherein upon determining that the specified domain name resolves correctly, the mapping file is no longer accessed.

13. At a domain name system (DNS) server including at least one processor and a memory, in a computer networking environment including a plurality of computing systems, a computer-implemented method for automatically redirecting DNS requests for DNS names while the DNS names are not resolvable, the method comprising:
an act of establishing a non-wildcard DNS entry for a specified domain name that maps to a specified service instance;
an act of inspecting packet headers for each received DNS request to determine which service instance was indicated in the DNS request; and
based on the determination, an act of forwarding incoming DNS requests for that service instance to the specified service instance.

14. The method of claim 13, wherein each non-wildcard DNS entry corresponds to a specific user.

15. The method of claim 14, wherein each user has one or more databases that include data that is to be provided by an associated service instance.

16. The method of claim 13, wherein each user registers for the non-wildcard DNS entry on a website provided by a hosting service.

17. The method of claim 13, wherein the specified domain name is selected by a user.

18. The method of claim 13, wherein each service instance serves a different set of customer databases.

19. A computer system comprising the following:
one or more processors;
system memory;
one or more computer-readable storage media having stored thereon computer-executable instructions that, when executed by the one or more processors, causes the computing system to perform a method for automatically redirecting DNS requests for DNS names while the DNS names are not resolvable, the method comprising the following:
an act of establishing a wildcard DNS entry for a specified domain name, wherein incoming DNS requests for that domain name are automatically forwarded to a load balancer;
an act of the load balancer inspecting packet headers for each received DNS request to determine which hostname was indicated in the DNS request;
an act of the load balancer accessing a mapping file to determine which back-end server the DNS request is to be redirected to based on the hostname indicated in the packet header;
based on the determination, an act of forwarding the received request to the determined back-end server;
an act of receiving registration information from a user, the registration information indicating a specified service and DNS name; and
an act of dynamically updating the mapping file to map to the service instance that the user's data is hosted on.

20. The computer system of claim 19, wherein upon determining that the specified domain name resolves correctly, the mapping file is no longer accessed.
